(19) United States
(12) Patent Application Publication
(10) Pub. No.: US 2005/0098660 A1
(43) Pub. Date: May 12, 2005

(54) Fuel-injection valve for internal combustion engines

(76) Inventors: Marco Ganser, Oberageri (CH); Andreas Carelli, Zurich (CH)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/474,502

(22) PCT Filed: Apr. 11, 2002
(86) PCT No.: PCT/CH02/00203

(30) Foreign Application Priority Data
Apr. 24, 2001 (CH) 744/01

(51) Int. Cl. F02M 59/00

(52) U.S. Cl. 239/533.2

(57) ABSTRACT

An injection valve member for closing or opening injection orifices of a valve seat element is integrated, in a longitudinally displaceable manner, into a central housing bore of a fuel-injection valve. The valve seat element is fixed to the housing and the part of the element that includes the injection orifices and the seat projects out of the housing. Elements for determining the rotational position of the valve seat element in relation to the housing are provided on the exterior of the part. The fuel injection valve requires simple production and assembly engineering and permits a slimline injector configuration for both large and small internal combustion engines.

The invention relates to a fuel injection valve for an intermittent fuel injection into the combustion space of an internal combustion engine.

A fuel injection valve of this type is disclosed in the older European patent application, publication number EP-A-1 118 765. The fuel injection valve has a housing with a central bore which extends in its longitudinal direction and in which is arranged longitudinally adjustably an injection valve member which is provided for the closing or opening of injection orifices of a valve seat element fastened in the housing. The valve seat element is pressed with its upper annular end face sealingly onto a lower annular end face of the housing by means of a union nut which can be screwed onto the housing. For fixing a defined rotary position of the valve seat element with respect to the housing, one or more pins are provided which run in the longitudinal direction and project into corresponding recesses in the end faces bearing against one another. In fuel injection valves for small internal combustion engines and for large internal combustion engines in which it is nevertheless important to have a slender injector design, this solution is unsatisfactory, since the space for these pins is often absent.

The object on which the present invention is based is to provide a fuel injection valve which is simple and cost-effective in terms of production and of assembly and in which a slender injector design is possible both for small and for large internal combustion engines. A further object is to propose a method for mounting a valve seat element on a housing of a fuel injection valve.

This object is achieved, according to the invention, by means of a fuel injection valve having the features of the independent claims 1 or 13 and a method according to claim 12.

Preferred developments of the fuel injection valve according to the invention form the subject matter of the dependent claims.

Fuel injection valves of the type initially mentioned, with a particularly preferred connection of the valve seat element to the housing, form the subject matter of the independent claims 16 and 18.

A particularly preferred method for fastening the valve seat element to the housing of the fuel injection valve is defined in claim 17.

The invention is explained in more detail below with reference to the drawings in which:

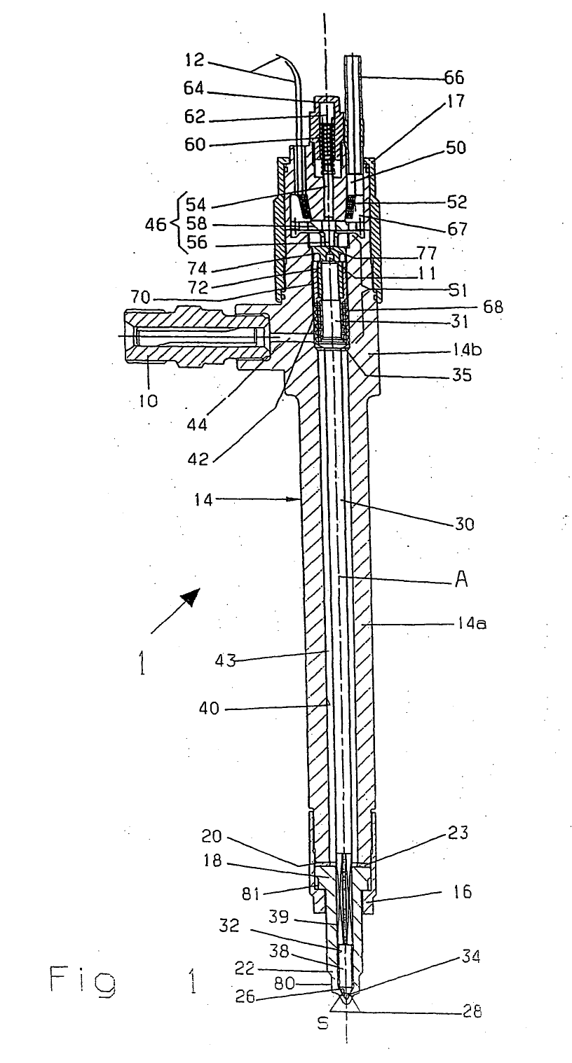

FIG. 1 shows an exemplary embodiment of a fuel injection valve in longitudinal section;

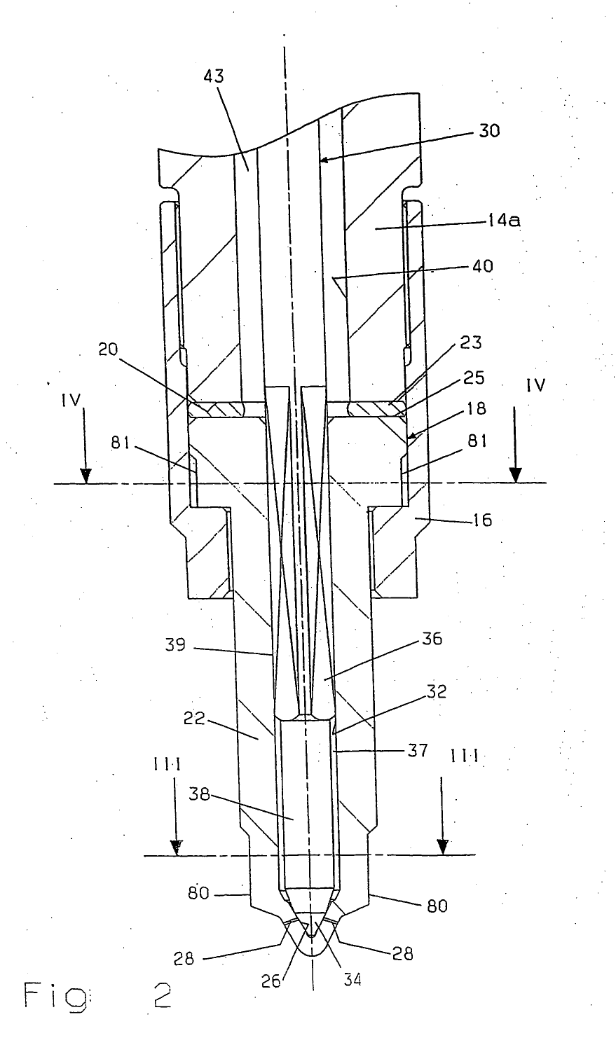

FIG. 2 shows, on an enlarged scale and in longitudinal section, a lower part of the fuel injection valve shown in FIG. 1, with a first exemplary embodiment of a valve seat element;

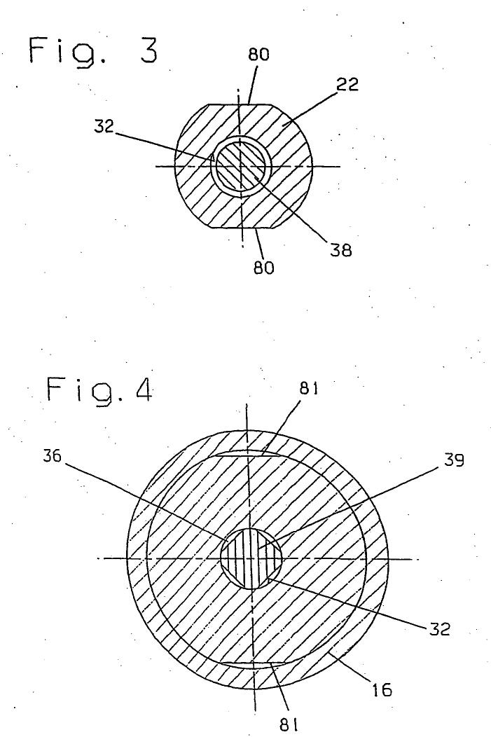

FIG. 3 shows a section along the line III-III in FIG. 2;

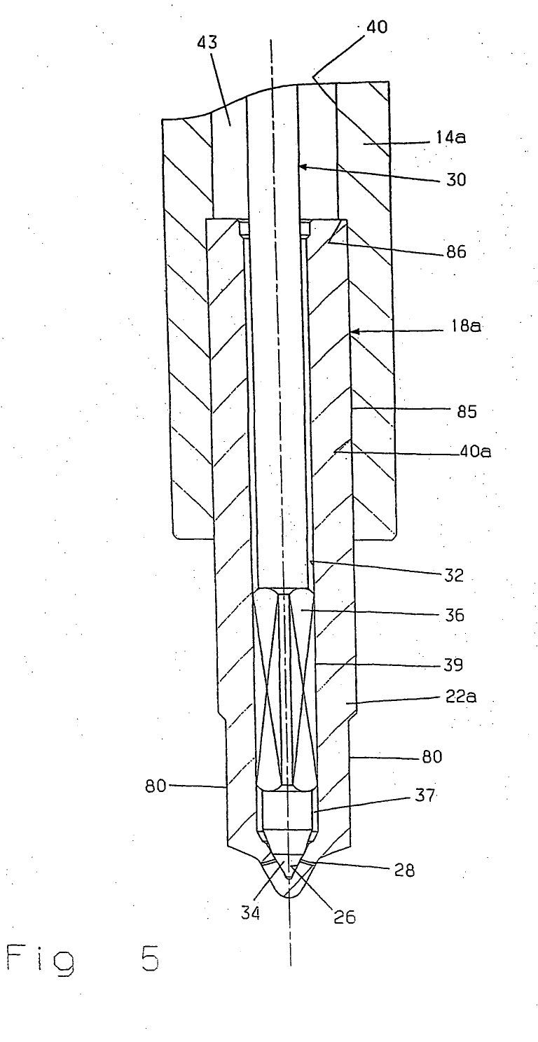

FIG. 4 shows a section along the line IV-IV in FIG. 2;

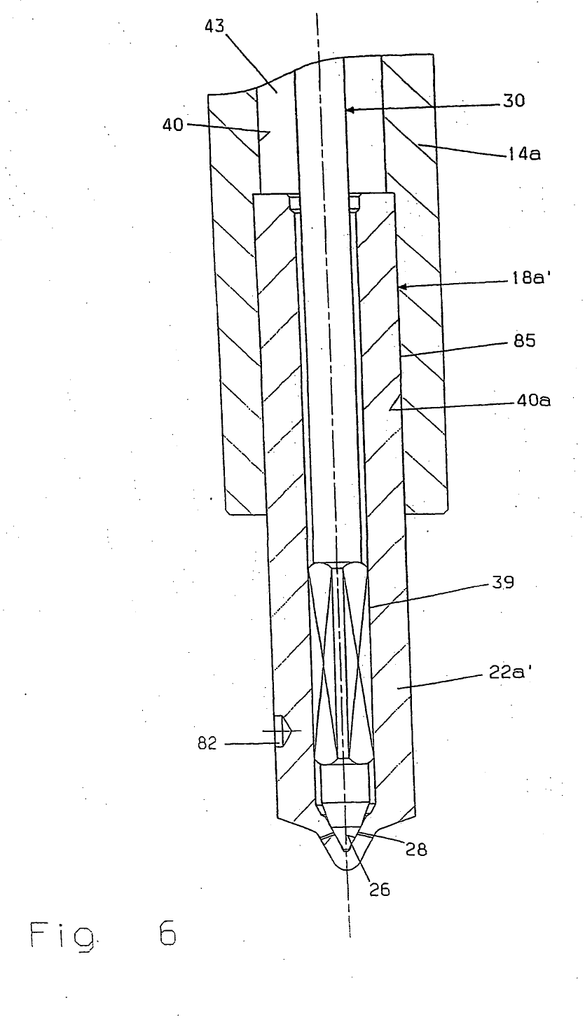

FIG. 5 shows an illustration, corresponding to FIG. 2, of a second embodiment of the lower valve part, with a second exemplary embodiment of a valve seat element;

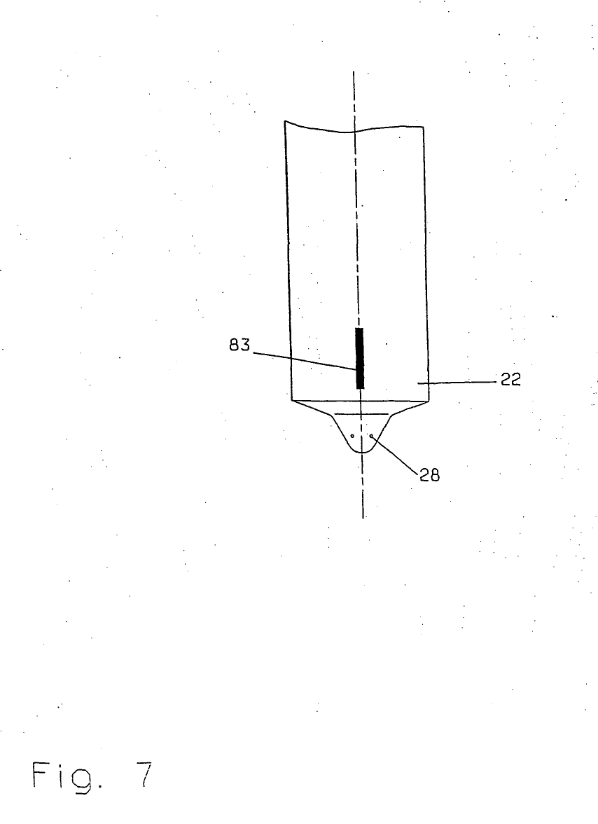

FIG. 6 shows a variant of the embodiment of the lower valve part according to FIG. 5, with a third exemplary embodiment of a valve seat element;

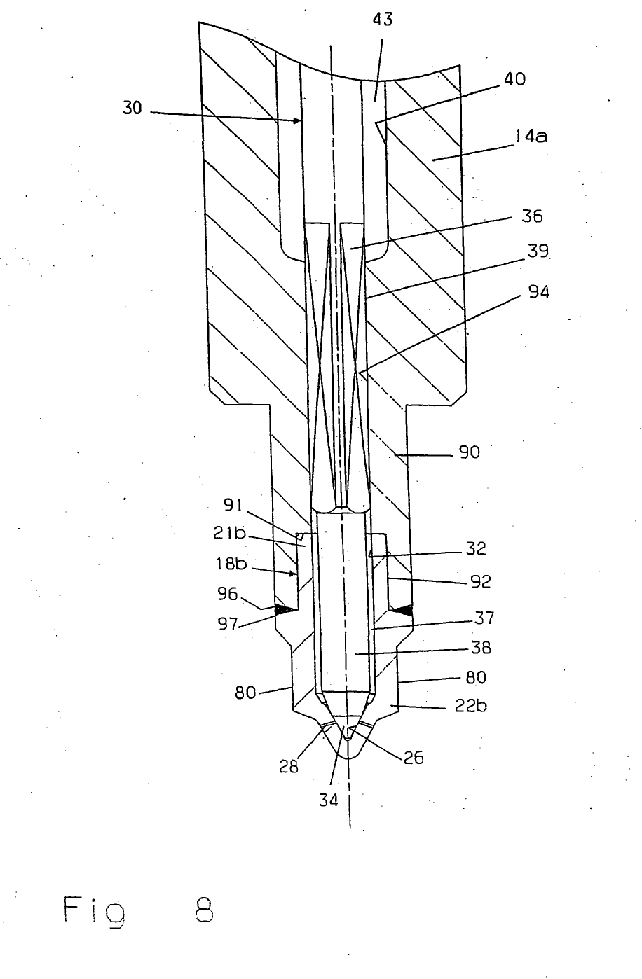

FIG. 7 shows a fourth exemplary embodiment of a valve seat element;

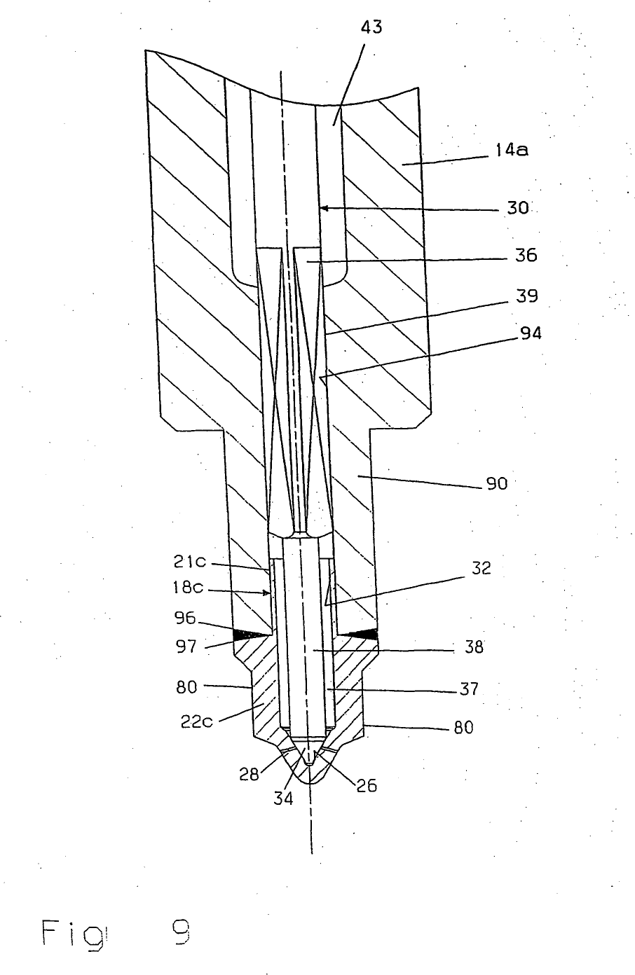

FIG. 8 shows a third embodiment of the lower valve part;

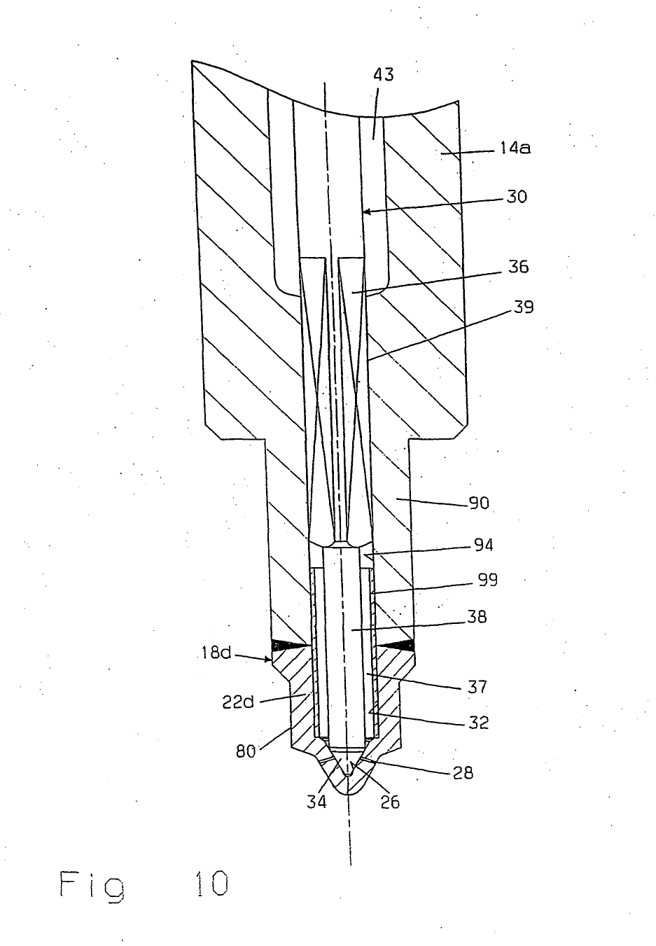

FIG. 9 shows a fourth embodiment of the lower valve part;

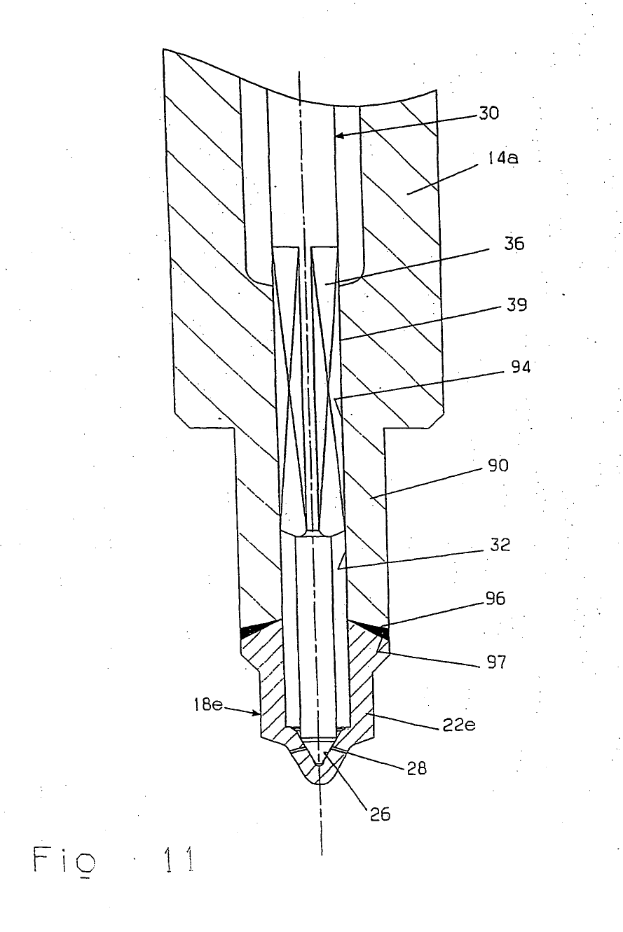

FIG. 10 shows a fifth embodiment of the lower valve part;

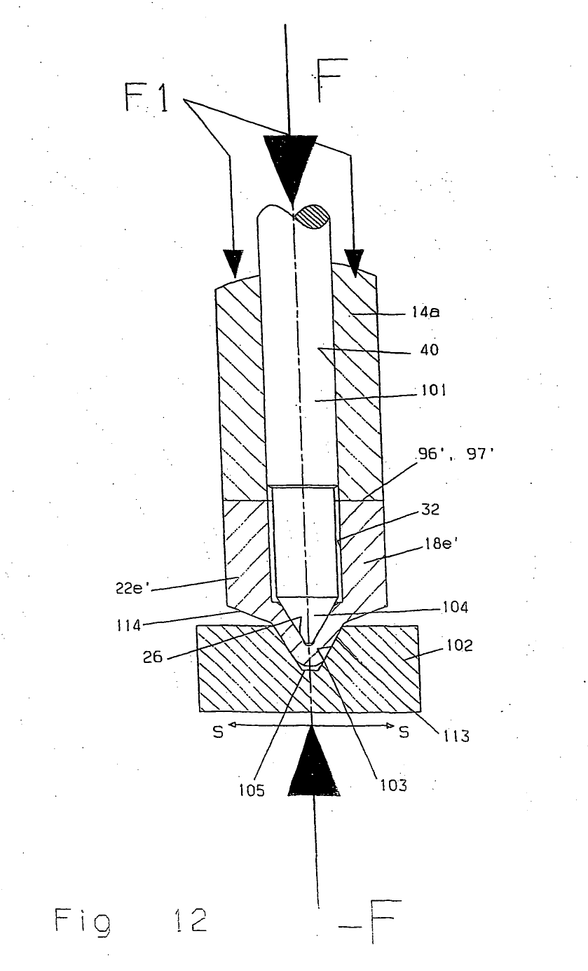

FIG. 11 shows a sixth embodiment of the lower valve part;

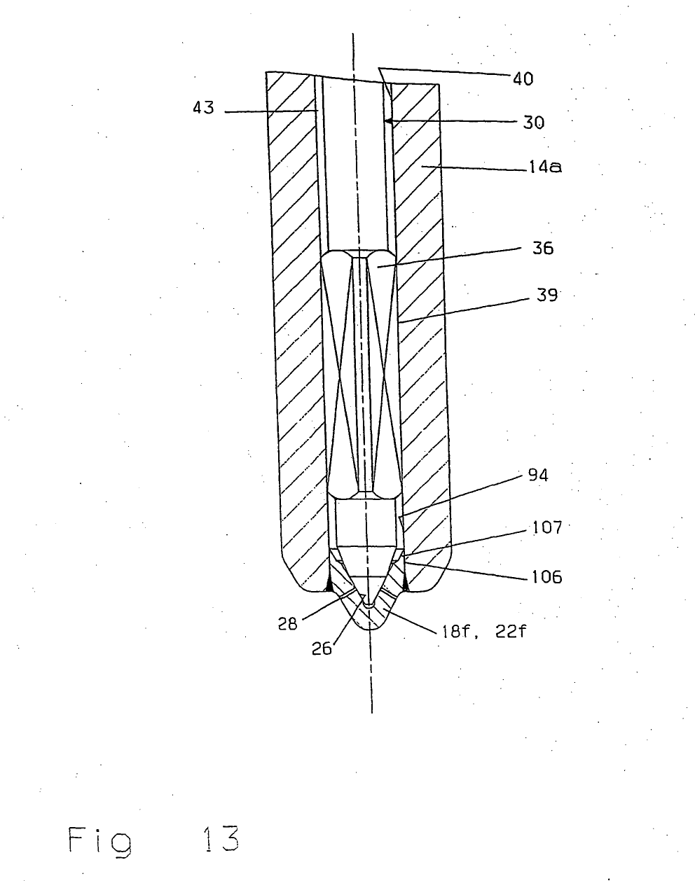

FIG. 12 shows diagrammatically an exemplary embodiment of a device for the welded connection of a valve seat element to a valve housing;

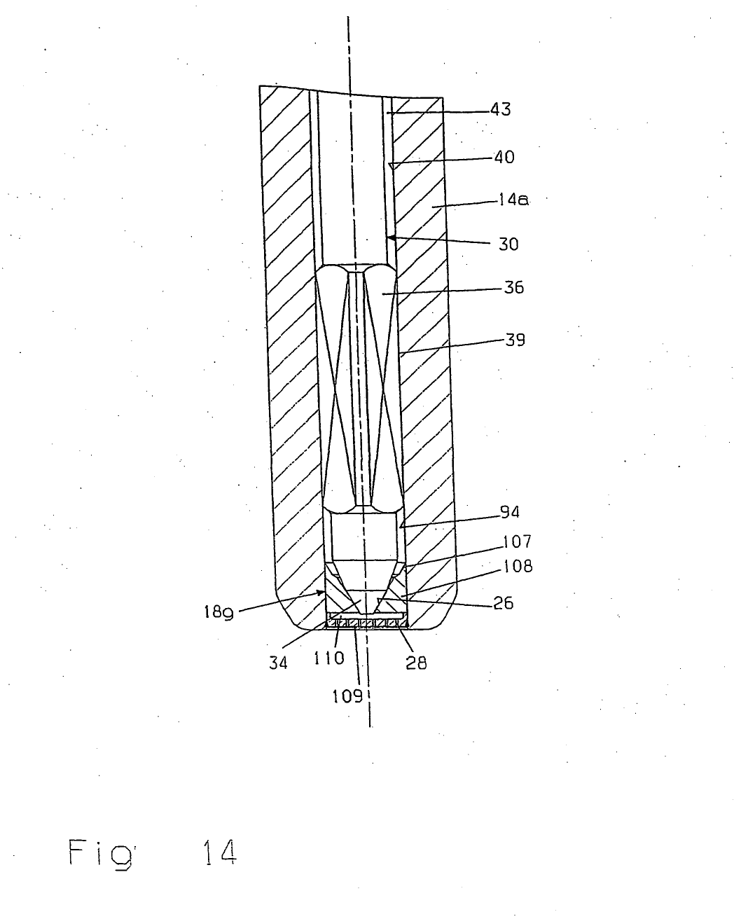

FIG. 13 shows a seventh embodiment of the lower valve part;

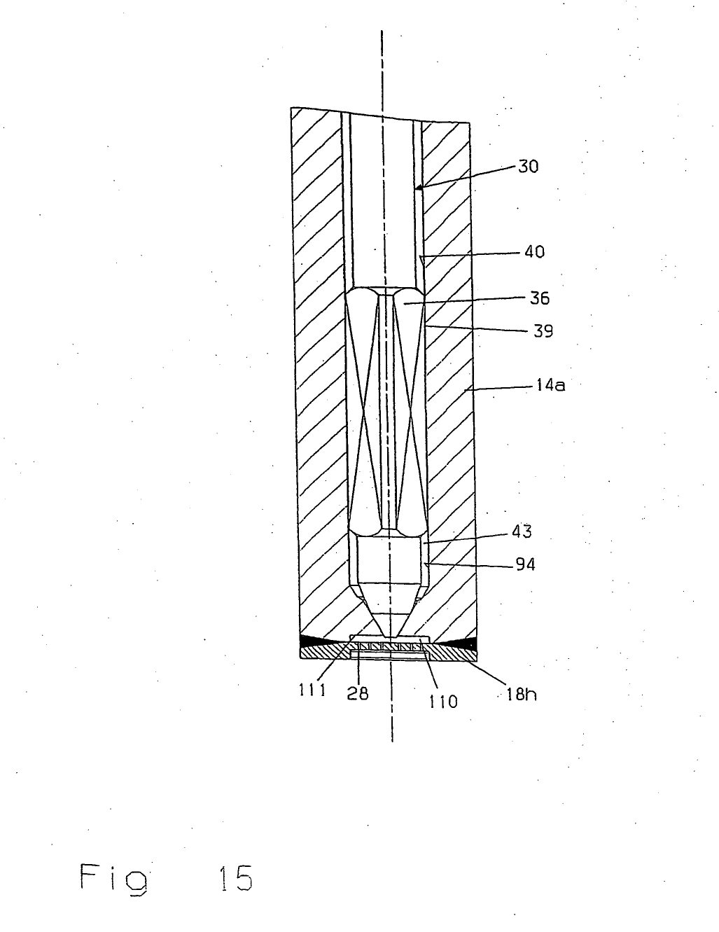

FIG. 14 shows a eighth embodiment of the lower valve part; and

FIG. 15 shows a ninth embodiment of the lower valve part.

According to FIG. 1, a fuel injection valve 1 is connected via a fuel high pressure connection 10 to a high pressure conveying means, not illustrated in the drawing, which delivers fuel with a pressure of 100 to 2000 bar and above. Furthermore, the fuel injection valve 1 is connected to an electronic control, likewise not shown, via electrical connections 12.

The fuel injection valve 1 has a housing 14 which comprises a lower housing part 14a and an upper housing part 14b. The lower housing part 14a is of tubular design, is long and is narrow in diameter and has a central bore 40 coaxial to the longitudinal axis A of the fuel injection valve 1. The central bore 40 is widened in the region of the upper housing part 14b. This bore of larger diameter is designated by 42 in FIG. 1. A passenger bore 44 connecting the fuel high pressure connection 10 to the widened part 42 of the central bore is arranged radially to the longitudinal axis A.

According to FIGS. 1 and 2, the lower housing part 14a is connected at its lower end to a screwed-on holding part 16 designed as a union nut. Inserted in the holding part 16 is a nozzle body 18, of which the nozzle tip 22 provided with a nozzle needle seat 26 and with a plurality of injection orifices 28 projects out of the holding part 16 and forms a valve seat element for a lower end 34 of an axially adjustable nozzle needle 30 forming an injection valve member. The injection orifices 28 of the nozzle tip 22 can be opened and closed by means of the lower end 34 of the nozzle needle 30. The nozzle body 18 is pressed with its upper end face 25 onto a lower face 20 of the lower housing part 14a by means of the holding part 16 via a washer 23, the metallic washer 23 provided with lapped end faces cooperating with the corresponding machined end face 25 and lower face 20, as a sealing element.

The nozzle needle 30 extends concentrically to the longitudinal axis A from the lower nozzle needle seat 26 through a bore or recess 32 of the nozzle body 18 and through the central bore 40 of the housing part 14a upwardly and in the upper end part has a collar 35 and a control piston 31. The control piston 31 forms part of a control device S1 for controlling the adjusting movement of the injection valve member, that is to say of the nozzle needle 30. The control device S1 illustrated in FIG. 1 corresponds to the control device S1 of the fuel injection valve described in EP-A-1 118 765 (FIGS. 2 and 3). Reference is therefore made to these patent applications for a detailed description of this control device S1 and of its functioning. Only those parts of this control device S1 which are important for understanding the basic functioning of the fuel injection valve are mentioned further below.

The nozzle needle 30 has, in the region of the nozzle body bore 32, a part 39 which is provided with axially running ground-down faces 36 and by means of which said nozzle needle is closely guided slideably in the bore 32 (a sliding fit of less than 20 μm is provided). The ground-down faces 36 are also evident from FIG. 4. This part 39 provided with ground-down faces 36 is connected to the lower end 34 of the nozzle needle via a part 38 of stepped diameter. The ground-down faces 36 ensure the hydraulic connection of an annular space 37 (cf. FIG. 2) surrounding the part 38 to the central bore 40 of the housing part 14a or to a space 43 surrounded by this bore 40.

In the exemplary embodiment illustrated in FIG. 1, the nozzle needle 30 is of one-piece design. The nozzle needle could, however, also consist of a plurality of elements operatively connected to one another.

A holding nut 17 is screwed onto the upper housing part 14b. Inside the holding nut 17 is accommodated an electromagnetically actuable pilot valve 46 which comprises an armature 58 firmly connected to a pilot valve stem 54. In a currentless state of an electromagnet 50, the pilot valve stem 54 is pressed downward by the force of a compression spring 60. The magnitude of this force can be set by means of a spring tensioning element 62. For actuating the pilot valve 46 or for raising the pilot valve stem 54 connected to the armature 58, an exciting coil 52, assigned to the armature 58, of the electromagnet 50 is supplied via the electrical connections 12 with control pulses from the electronic control.

The spring tensioning element 62 is accommodated in a closing-off part 64 sealingly closing off the fuel injection valve 1 at its upper end. The holding nut 17 has installed in it, together with the electromagnet 50, a fuel return connection 66 which is connected to a space 67, what is known as a low pressure zone, which surrounds the pilot valve 46 and in which fuel of low pressure flows.

The central housing bore 40 or its part 42 of widened diameter is sealingly closed off at the top by means of a control body 74 fixed to the housing. The control body 74, forming part of the control device S1, has an outlet orifice 77 which can be opened or closed as a result of the actuation of the pilot valve 46 or by the pilot valve stem 54 being raised or lowered. The outlet orifice 77 connects a control space 11, arranged above the control piston 31, to the low pressure zone 67. The control space 11 has, in a way known per se and not described in any more detail here, a throttle connection to the central housing bore 40 which belongs to the high pressure zone connected to the fuel high pressure connection 10.

The control piston 31 is acted upon, on the one hand, by the fuel system pressure prevailing in the high pressure zone and, on the other hand, by the fuel control pressure in the control space 11. By means of a closing spring or nozzle needle spring 68, which is pretensioned between the collar 35 of the nozzle needle 30 and a sleeve-shaped part 70, surrounding the control piston 31, of the control device S1, the nozzle needle 30 is pressed downward in the closing direction of the fuel injection valve 1 and is held reliably against the fuel high pressure exerted on the nozzle needle 30. The pretensioning force of the nozzle needle spring 68 must be relatively high and may amount, for example, to 100 to 300 N.

The stroke of the nozzle needle 30 is, as a rule, about 0.2 to 0.4 mm. By the choice of a suitable thickness of the washer 23 already mentioned, the needle stroke can be adapted in relation to the nozzle needle seat 26 (tolerance compensation).

FIG. 1 shows the fuel injection valve 1 in a position prior to the injection operation. In the control space 11 closed by the pilot valve stem 54, the same high pressure prevails as in the high pressure zone, that is to say as in the space 37, 43 which is surrounded by the housing bores 42, 40 and the bore 32 and which extends as far as the nozzle needle seat 26 and surrounds the nozzle needle 30. As soon as a pulse of selected duration is supplied to the electromagnet 50 via the electronic control, the armature 58 is pulled out counter to the force of the compression spring 60 and the pilot valve stem 54 of the pilot valve 46 is thus raised. The pilot valve stem 54 opens the outlet orifice 77 of the control body 74. The pressure in the control space 11 falls, and the opening movement of the nozzle needle 30 is controlled via the control device S1. The injection operation is initiated.

To terminate the injection operation, the pilot valve 46 is brought into its closing position via the electromagnet 50, again by electronic control. The outlet orifice 77 is closed again, and the pressure in the control space 11 rises again, the sequence of this operation again being controlled by the control device S1.

An essential advantage of the fuel injection valve 1 according to the invention is that the high pressure zone, that is to say the space 37, 43 concentrically surrounding the nozzle needle 30 from the nozzle needle seat 26 via the bore 32 and the housing bores 40, 42, the passenger bore 44, and also the control space 11 as far as the outlet orifice 77, forms a fully sealed region without leakage points.

By the choice of an appropriate diameter of the central housing bore 40 surrounding the nozzle needle 30 in its middle region, the space 43 containing the compressible fuel can be defined in varying size in terms of its cross section or of its volume, and, as a result, the instantaneous transient pressure drop in the high pressure zone during the injection operation can be kept within desired limits, depending on the use of the fuel injection valve 1, that is to say depending on the engine size. In the case of a smaller cross section, that is to say in the case of a smaller accumulator volume in the high pressure zone, the pressure drop is greater than in the case of a large cross section. The choice of a large cross section, that is to say of a larger inside diameter of the central housing bore 40, with the same diameter of the nozzle needle 30, means, however, that the housing wall becomes thinner in this region, since the outside diameter of the housing 14 or of the lower housing part 14a cannot be increased, as desired, for reasons of space (a slender design of the injector is important for installing the fuel injection valve in the cylinder head of an internal combustion engine). With previous fuel injection valves (cf. the fuel injection valve already mentioned according to FIG. 1 of EP-A-1 118 765), a specific wall thickness of the housing was necessary, so that pins securing the defined rotary position of the valve seat element with respect to the housing could be accommodated. To be precise, while the rotary position of the housing 14 is determined by the internal combustion engine, the nozzle body 18 forming the valve seat element must be set and fixed in its rotary position with respect to the housing 14 according to the engine design, so that one of the injected fuel jets reliably enters the region of the glow plug in the combustion space of the internal combustion engine.

So that, even in the case of slender injectors, the rotary position of the nozzle body 18 can be defined with respect to the housing 14 without difficulty and the diameter of the central housing bore 40 surrounding the nozzle needle 30 in its middle region can nevertheless at the same time be selected freely (that is to say, the injectors can also have a thin-walled design), according to the invention positioning faces 80 running in the axial direction are formed on the circumference of the nozzle body part projecting out of the holding part 16, that is to say on the circumference of the nozzle tip 22. Preferably, the nozzle tip 22 has two parallel plane positioning faces 80, as is evident from FIG. 3. In the exemplary embodiment illustrated in FIGS. 1 and 2 and also in FIG. 4, the nozzle body 18 is also provided in its region located inside the union nut or the holding part 16 with preferably two reference faces 81 parallel to one another and to the positioning faces 80. These reference faces 81 serve for positioning or chucking the nozzle body 18 provided with the positioning faces 80, during the manufacture of the injection orifices 28. If, however, both the positioning faces 80 and the injection orifices 28 are manufactured on the same machine, that is to say with the same chucking, the reference faces 81 may be dispensed with. The reference faces 81 may also be dispensed with when the positioning faces 80 can at the same time serve directly as reference faces during the manufacture of injection orifices 28.

As already mentioned, the pressure drop in the high pressure zone is dependent on the cross section and accumulator volume of the latter. What is critical for fixing this volume is the cross section which is determined by the central housing bore 40 and the nozzle needle 30 and which remains constant over a large part of the valve length. The cross-sectional narrowing within the nozzle body 18 does not cause any inadmissible long-lasting pressure drop in the high pressure zone during the opening of the injection orifices 28, since this cross-sectional narrowing extends only about the length of 30 to 40 mm, and, in the case of an injection time of about 1 ms, the transient time, determining the pressure drop, of the pressure pulsation within this zone of narrowed cross section amounts to only about 30 to 40 μs (according to the sound velocity in the fuel).

FIG. 5 shows a second exemplary embodiment of a nozzle body 18a forming a valve seat element and of the arrangement of said nozzle body in the lower housing part 14a. Once again, a nozzle tip 22a provided with the nozzle needle seat 26 and with the injection orifices 28 projects out of the housing part 14a. In this exemplary embodiment, there is no union nut for fastening the nozzle body 18a in the housing part 14a, but, instead, the nozzle body 18a is sealingly pressed from below, in the correct rotary position with respect to the housing 14 which is given by the positioning faces 80, with a press fit 85 into a part 40a of the housing bore 40, until said nozzle body comes to bear in the axial direction against a step face 86 in the housing bore 40. That part 39 of the nozzle needle 30 which is provided with the ground-down faces 36 and is guided in the nozzle body bore 32 with a close sliding fit of less than 20 μm is shifted nearer toward the lower end 34, as compared with the exemplary embodiment according to FIGS. 1 and 2, and is located in the region of the nozzle tip 22a projecting out of the housing part 14a, that is to say outside the press fit region 85. In the region of the press fit 85, the nozzle needle 30 is stepped in diameter with respect to the part 39, so that the pressing of the nozzle body 18a into the housing 14 does not result in any adverse influence on the nozzle needle movement.

It would be possible for the ground-down faces 36 connecting the spaces 37, 43 to be designed continuously, in a similar way to the version according to FIGS. 1 and 2, but the part 39 would have to be stepped slightly in diameter in the region of the press fit 85, so that the close sliding fit for nozzle needle guidance is not impaired by the nozzle body 18a being pressed in.

The nozzle body 18a or its nozzle tip 22a is also provided with the positioning faces 80 described above.

Instead of the positioning faces 80, however, the nozzle body 18a according to FIG. 5 (or its nozzle tip 22a projecting out of the housing 14) or the nozzle body 18 according to FIG. 1 to 4 (or its nozzle tip 22 projecting out of the housing 14) could be provided with a centering countersink (or a plurality of centering countersinks) for defining its rotary position with respect to the housing 14, as illustrated in FIG. 6 by the example of a nozzle body 18a′. The centering countersink is designated by 82 in FIG. 6. It is a round centering countersink 82 which is provided for a centering pin and which is formed on the circumference of the nozzle tip 22a′ projecting out of the housing part 14a.

The means for defining the rotary position of the nozzle body 18 or 18a with respect to the housing 14 could also be formed by a visually readable marking formed on the circumference of the nozzle tip 22 or 22a projecting out of the housing part 14a. In FIG. 7, a nozzle tip 22′ is depicted by a dash marking 83. Instead of a dash (or a plurality of dashes), however, dots, small circular areas or the like could also be formed as a marking on the nozzle tip 22′.

In the third exemplary embodiment, illustrated in FIG. 8, of a lower valve part, a nozzle body 18b, which is relatively short, as seen in the longitudinal direction, is inserted from below with its upper sleeve-shaped part 21b into a lower part 90, of stepped outside diameter, of the housing part 14a or into a recess 92 of the latter and is supported axially on a supporting face 91. The nozzle body 18b has a nozzle tip 22b provided with the nozzle needle seat 26 and with the injection orifices 28. This small nozzle body 18b, which must be hardened, is welded to the part 90, the weld seam being provided between two end faces 96, 97 of these two parts 90, 18b. The weld seam here also assumes the sealing-off function. For defining the rotary position of the nozzle body 18b with respect to the housing 14 prior to welding, positioning faces 80 are once again formed on the circumference of the nozzle tip 22b (here, too, a centering countersink 82 or marking 83 could be used instead of positioning faces 80). In this exemplary embodiment, nozzle needle guidance does not take place in the nozzle body 18b, as in the variants described above, but in the lower housing part 14a. The central housing bore 40 is narrowed in the lower region to a guide bore 94 in which the nozzle needle 30 is closely guided slideably with its part 39 having the ground-down faces 36. The guide bore 94 corresponds in its diameter to the nozzle body bore 32 extending as far as the nozzle needle seat 26. The nozzle body 18b must be guided or centered accurately in the recess 92, so that the nozzle needle seat 26 is aligned coaxially with the nozzle needle 30 guided in the housing part 14a. Moreover, this exact guidance in the recess 92 prevents tilting during welding.

The short design of the nozzle body 18b makes it possible that a short grinding arbor can advantageously be used for grinding the nozzle needle seat 26. Moreover, a holding part 16 (FIG. 1, 2) or a press fit 85 (FIG. 5, 6) may be dispensed with.

The fourth exemplary embodiment, illustrated in FIG. 9, differs from that according to FIG. 8 in that the upper sleeve-shaped part 21c of the nozzle body 18c has a thin-walled design and projects directly into the guide bore 94 of the housing part 14a (that is to say, no additional recess 92 is provided in the housing 14). By means of the fuel system pressure prevailing within the bore 32 or in the space 37, the thin-walled upper part 21c is pressed sealingly onto the wall of the guide bore 94. The weld seam between the housing part 14a or 90 on the nozzle body 18c needs to absorb only the axial forces here, while sealing is ensured by the widening part 21c. Here, too, the nozzle body 18c has positioning faces 80 for positioning in the desired rotary position.

In the fifth variant, illustrated in FIG. 10, in comparison with the version according to FIG. 9, the thin-walled upper part 21c known from FIG. 9 is dispensed with in the nozzle body 18d; the nozzle body 18d has been held in a coaxial position to the nozzle needle 30 by means of a centering sleeve 99 which, on the one hand, projects into the guide bore 94 and, on the other hand, is inserted into the nozzle body bore 32, and has then been welded to the housing part 14a or 90. In this exemplary embodiment, too, the thin-walled centering sleeve 99 is widened by the fuel system pressure and is pressed sealingly against the walls of the bores 32, 94, so that, in this variant too, the weld seam assumes merely the absorption of the axial forces, but not the sealing-off function. The nozzle tip 22d, too, is equipped with means for defining the rotary position with respect to the housing 14 (if appropriate, with positioning faces 80).

FIG. 11 also shows a nozzle body 18e welded to the lower housing part 14a or 90, in this version no special structural means being provided for centering the nozzle body 18e with respect to the housing part 14a, apart from conically arranged end faces 96, 97 of the housing part 14a, on the one hand, and of the nozzle body 18e, on the other hand, said end faces being provided for welding the two parts 14a, 18e together. So that, even in this version, an exact coaxial position of the nozzle needle 30 closely guided slideably in the housing guide bore 94 is ensured with respect to the nozzle needle seat 26 of the nozzle body 18e fastened to the housing 14 by means of welding, the welding of the nozzle body 18e is carried out in the way described with reference to FIG. 12.

The parts 18e′ and 14a according to FIG. 12 which are to be welded together differ from those according to FIG. 11 in that the end faces 96′, 97′ to be welded together are not conical, but are arranged in a plane perpendicular to the longitudinal axis of the respective part 18e′, 14a.

To weld the nozzle body 18e′ to the lower housing part 14a, the nozzle body 18e′ is pressed with a high pressure force F against a countertool 102 by means of a positioning tool 101 introduced into the central housing bore 40 and the nozzle body bore 32. The positioning tool 101 bears with an end portion 104 corresponding to the nozzle needle end 34 on the nozzle needle seat 26 and presses the nozzle tip 22e′ with its conical part 113 onto a conical counterface 103 of a recess 105 of the countertool 102. The housing part 14a is pressed with its end face 96′ onto the end face 97′ of the nozzle body 18e′ with a lower force F1 (caused, for example, by spring pretension). The positioning tool 101 is guided exactly within the housing bore 40, but is stepped in diameter shortly above the parting plane of the two parts 14a, 18e′ to be welded together (and as far as the end portion 104), so that there is sufficient space radially for any welding bead. As indicated by arrows S in FIG. 12, in the design with the end faces 96′, 97′ lying in one plane, the countertool 102, together with the nozzle body 18e′, can be displaced laterally, that is to say oriented in the transverse direction with respect to the positioning tool 101, before the actual welding operation commences. In the embodiments according to FIG. 8 to 10, too, welding is advantageously in each case simultaneously carried out symmetrically at two opposite points.

The advantage of the welding device according to FIG. 12 is that the seat face 26 of the nozzle body 18e′ is positioned exactly on the axis of the housing part 14a and, owing to the high pressure force F, is also held during the welding operation, thus ensuring the functioning of the parts after welding.

In the embodiment according to FIG. 12, too, the nozzle body 18e′ may have means for positioning in the desired rotary position.

The countertool 102 or the recess 105 could also be configured in such a way that, instead of the acute-angled conical part 113 of the nozzle tip 22, the obtuse-angled part 114 of said nozzle tip could also serve for supporting the nozzle body 18e or 18e′.

In the exemplary embodiment according to FIG. 13, too, there is a nozzle body 18f welded to the lower housing part 14a, but this is, here, an extremely small part which forms only the nozzle tip 22f and which has the nozzle needle seat 26 and the injection orifices 28. This nozzle body 18f is inserted with its circumferential face 106 from below directly into the central housing bore 40 or into the guide bore 94 for that part 39 of the nozzle needle 30 having the ground-down faces 36 and is welded from below. The nozzle body 18f has in its upper region a thin-walled lip 107 which is pressed sealingly against the housing inner wall by the high pressure prevailing in the housing bore 40. In this version, too, preferably a marking is formed on the circumference of the nozzle tip 22f projecting out of the housing part 14a, in order to define the rotary position of the nozzle body 18f with respect to the housing 14.

In all the variants described above, the means according to the invention for defining the housing/nozzle body rotary position make it possible to have a slender injector design, specifically both for small and for large internal combustion engines.
However, a slender injector design is also possible in the embodiments of the lower valve part which are evident from FIGS. 14 and 15.

FIG. 14 likewise shows a nozzle body 18g which is inserted into the central housing bore 40 or guide bore 94 and which has, on the one hand, an upper part 108 provided with the nozzle needle seat 26 and with a thin-walled sealing-off lip 107 and, on the other hand, a lower part 109 provided with a number of axially directed injection orifices 28 parallel to one another. The lower part 109 is welded at its circumference together with the housing part 14a from below. By means of the lower end 34, bearing on the nozzle needle seat 26, of the nozzle needle 30, the space 43 belonging to the high pressure zone and located within the bore 40 is separated from a space 110 leading to the injection orifices 28, and the injection orifices 28 are thereby as it were kept closed. In this version, the defining of the rotary position of the nozzle body 18g with respect to the housing 14 is dispensed with completely, since the fuel jet injected out of all the injection orifices 28 into the combustion space of the internal combustion engine, with the nozzle needle 30 lifted off from the nozzle needle seat 26, remains in the same direction in any rotary position, directed axially with respect to the fuel injection valve.

The same also applies to the variant illustrated in FIG. 15. Here, a nozzle body 18h provided with a number of axially directed injection orifices 28 parallel to one another is welded to the lower housing part 14a on the end face. In this version, the nozzle needle seat 26 is not manufactured in the nozzle body 18h, but in the housing part 14a, as a lower part of the housing bore 40 or of the guide bore 94. The lower housing part 14a has an end-face recess 111 delimiting the space 110 leading to the injection orifices 28. The connection of the space 110 or of the injection orifices 28 to the high pressure zone may again be kept open or closed by means of the nozzle needle 30 cooperating with the nozzle needle seat 26.

In all the variants, the injection valve member or the nozzle needle 30 can be installed in the essentially tubular housing 14 from above in a simple way.

In the embodiments according to FIGS. 14 and 15, it is also conceivable to provide the part 109 or the nozzle body 18h with a means for defining the rotary position with respect to the housing during fastening to the latter. This would have advantages particularly if the injection orifices 28 or not all the injection orifices 28 were to be directed axially with respect to the fuel injection valve 1.

It is also possible, instead of the means described further above, formed on the outside, for defining the rotary position of the valve seat element 18; 18a; 18a′; 18b; 18c; 18d; 18e; 18e′; 18f with respect to the housing 14, to use the injection orifices 28 themselves for this purpose during the fastening of said valve seat element to the latter. In this case, the position of one or more of the injection orifices 28 can be detected by means of a, for example, optical sensor, and the valve seat element can then be brought together with the housing 14 in the desired rotary position, for example by means of a robot. For detecting the rotary position of the valve seat element, it is possible, for example, to use an image-processing system with, as a sensor, a television camera or digital photographic camera, the signals from which are evaluated by means of a computer and transmitted, processed, to a control means for controlling the robot. After the valve seat element and the housing 14 have been brought together with the correct rotary position, the valve seat element is fastened to the housing, as described further above, for example by means of a union nut, by welding or by means of a press fit. The fastening operation may likewise be carried out by means of a robot.

1-21. (canceled)

22. A fuel injection valve for intermittent fuel injection into a combustion space of an internal combustion engine, comprising:
a) a housing;
b) a valve seat element including a seat provided with injection orifices;
c) means for fastening the valve seat element to the housing, the valve seat element projecting with a part having the seat out of the housing;
d) an injection valve member arranged longitudinally adjustably in the housing and configured to cooperate with the seat;
e) a control device for controlling adjusting movement of the injection valve member;
f) a central housing bore that runs in a direction of a longitudinal axis of the housing and in which the injection valve member runs and that is connected to a fuel high pressure connection and to the seat for the injection valve member; and
g) that part of the valve seat element that has the seat and projects out of the housing is provided on its outside with means for defining a rotary position of the valve seat element with respect to the housing during fastening of said valve seat element to the housing.

23. The fuel injection valve as claimed in claim 22, wherein the means for defining the rotary position of the valve seat element with respect to the housing is formed by a positioning face, centering countersink, or visually readable marking formed on an outside of the part projecting out of the housing.

24. The fuel injection valve as claimed in claim 22, wherein the injection valve member is closely guided with a part slideably in a bore, said bore extending as far as the seat provided with the injection orifices, of the valve seat element, this part slideably in the bore being provided on its circumference with ground-down faces, by which the central bore is connected to the seat.

25. The fuel injection valve as claimed in claim 22, wherein the means for fastening the valve seat element to the housing comprises a union nut configured to be screwed onto the housing, and a metallic washer is provided with lapped end faces arranged between an upper face of the valve seat element and a lower face of the housing.

26. The fuel injection valve as claimed in claim 24, wherein the valve seat element is inserted sealingly by a press fit into a part of the central housing bore and is supported axially on a step face, that part of the injection valve member which is provided with ground-down faces being closely guided slideably in a region of the bore located outside the housing, and, in the press fit region, the injection valve member being stepped in diameter with respect to the part provided with ground-down faces.

27. The fuel injection valve as claimed in claim 22, wherein the injection valve member is closely guided slideably, with a part provided with ground-down faces, in a guide bore of the housing or of a lower housing part, and the valve seat element has a short design, as seen in a longitudinal direction of the fuel injection valve, and is welded together with the lower housing part such that the longitudinal axis of the valve seat element is arranged coaxially to an axis of the guide bore.

28. The fuel injection valve as claimed in claim 27, further comprising means for centering the valve seat element with respect to the housing or to the guide bore.

29. The fuel injection valve as claimed in claim 27, wherein the valve seat element is inserted with part of its outer face from below into the guide bore and is welded into the guide bore, the guide bore being sealed off by at least one of a weld seam and a thin-walled valve seat element part pressed sealingly against the wall of the guide bore by the fuel system pressure prevailing in the guide bore.

30. The fuel injection valve as claimed in claim 28, wherein the valve seat element is welded to the housing on an end face and has a bore that extends as far as the seat provided with the injection orifices and that is connected to the central housing bore by the guide bore, the means for centering the valve seat element with respect to the guide bore being formed by a sleeve-shaped thin-walled valve seat element part projecting into the guide bore from below, this part projecting into the guide bore configured to be pressed sealingly against a wall of the guide bore by fuel system pressure prevailing in the bore.

31. The fuel injection valve as claimed in claim 28, wherein the valve seat element is welded sealingly on an end face to the housing and has a bore that extends as far as the seat provided with the injection orifices and that is connected to the central housing bore by the guide bore, the means for centering the valve seat element with respect to the guide bore being formed by a sleeve-shaped valve seat element part projecting from below into a recess coaxial to the guide bore.

32. The fuel injection valve as claimed in claim 28, wherein the valve seat element is welded on an end face to the housing and has a bore that extends as far as the seat provided with the injection orifices and that is connected to the central housing bore by the guide bore, the means for centering the valve seat element with respect to the guide bore being formed by a centering sleeve that projects, at a first end, into the guide bore and, at a second end, into the valve seat element bore and that is configured to be pressed sealingly against walls of the two bores by the fuel system pressure.

33. A method for mounting a valve seat element having a seat provided with injection orifices in a defined rotary position on a housing of a fuel injection valve configured for intermittent fuel injection into a combustion space of an internal combustion engine, comprising:
detecting a position of at least one of the injection orifices by a sensor; and
positioning the valve seat element into the defined rotary position as a function of a signal from the sensor and mounting the valve seat element on the housing.

34. A fuel injection valve for intermittent fuel injection into a combustion space of an internal combustion engine, comprising:
a) a housing with a central housing bore running in a longitudinal direction and connected to a fuel high pressure connection;
b) an injection valve member arranged longitudinally adjustably in the housing bore and that cooperates with a valve seat and by which a connection between the housing bore and a space leading to injection orifices can be made and broken;
c) a control device for controlling adjusting movement of the injection valve member;
d) wherein the injection valve member is closely guided with a part slideably in a guide bore forming a lower part of the housing bore; and
e) wherein the injection orifices are manufactured in a nozzle body welded to the housing.

35. The fuel injection valve as claimed in claim 34, wherein the nozzle body is inserted into the guide bore from below and is welded on its circumference together with the guide bore, a part which forms the valve seat being arranged in the guide bore above the nozzle body and being pressed against the nozzle body by the fuel system pressure prevailing in the guide bore, and with a thin-walled sealing-off lip against a wall of the guide bore.

36. The fuel injection valve as claimed in claim 34, wherein the nozzle body is welded together with the housing on an end face, and the valve seat is formed by a conically narrowing part of the central housing bore, said part being adjacent to the guide bore.

37. A fuel injection valve for intermittent fuel injection into a combustion space of an internal combustion engine, comprising:
a) a housing;
b) a valve seat element including a seat;
c) the valve seat element connected to the housing by a union nut configured to be screwed onto the housing, such that said valve seat element projects with a part having the seat out of the housing;
d) an injection valve member arranged longitudinally adjustably in the housing and cooperating with the seat;
e) a control device for controlling adjusting movement of the injection valve member;
f) a central housing bore that runs in a direction of a longitudinal axis of the housing and in which the injection valve member runs and which is connected to a fuel high pressure connection and to the seat;
g) the injection valve member is closely guided with a part slideably in a bore of the valve seat element, said bore extending as far as the seat; and
h) a metallic washer arranged between an end face of the valve seat element and a lower face of the housing.

38. The fuel injection valve as claimed in claim 37, wherein a thickness of the washer is selected such that the injection valve member executes a predetermined maximum stroke during opening and closing of the valve.

39. A fuel injection valve for intermittent fuel injection into a combustion space of an internal combustion engine, comprising:
a) a housing with a central housing bore running in a longitudinal direction and connected to a fuel high pressure connection;
b) a valve seat element including a seat;
c) an injection valve member arranged longitudinally adjustably in the housing bore and cooperating with the seat;
d) a control device for controlling adjusting movement of the injection valve member;
e) the valve seat element is inserted sealingly with a press fit into a part of the central housing bore and is supported axially on a step face, a part of the valve seat element that has the seat projecting out of the housing;
f) the injection valve member is closely guided with a part slideably in a bore of the valve seat element, said bore extending as far as the seat;
g) that part of the injection valve member which is closely guided slideably in the bore of the valve seat element has on its circumference ground-down faces, by which the central housing bore is connected to the seat;
h) that part of the injection valve member that is closely guided slideably in the bore of the valve seat element is located in a region of the valve seat element that projects out of the housing; and
i) the injection valve member is stepped in diameter in the press fit region of the valve seat element.

40. A method for fastening a valve seat element with a central bore and a valve seat to a housing, provided with a central housing bore, of a fuel injection valve, the valve seat being provided for cooperation with an injection valve member arranged longitudinally adjustably in the housing bore, the method comprising:
placing the valve seat element onto a countertool corresponding in its shape to it and pressing with a pressure force onto the countertool by a positioning tool that corresponds in its form essentially to its injection valve member and that is guided in a guide bore of the housing, said guide bore being provided for the injection valve member and forming part of the central housing bore;
pressing end faces of the valve seat element and of the housing against one another with a lower force;
a welding operation, simultaneously at two opposite points, in a region of end faces on a circumference of the parts to be connected together.

41. The method as claimed in claim 40, wherein a radial gap for a welding bead is provided in the region of the end faces between the positioning tool and the parts to be connected.

42. The method as claimed in claim 40, wherein, with the end faces lying in one plane, the positioning tool is stepped in diameter in the region of the end faces and in the region lying below them and extending as far as the valve seat, and the countertool, together with the valve seat element, can be adjusted in a transverse direction prior to the welding together and can thus be aligned radially with respect to the positioning tool.
